(19) United States
(12) Patent Application Publication
(10) Pub. No.: US 2009/0303679 A1
(43) Pub. Date: Dec. 10, 2009

(54) MEMORY MODULE

(75) Inventors: Min-Lang CHEN, Taipei (TW); Yuan-Sen TSAI, Taipei (TW); Chi-Han HSIEH, Taipei (TW)

Correspondence Address: Workman Nydegger;1000 Eagle Gate Tower, 60 East South Temple, Salt Lake City, UT, 84111, US

(73) Assignee: INVENTEC CORPORATION, Taipei (TW)

(21) Appl. No.: 12/193,351

(22) Filed: Aug. 18, 2008

(30) Foreign Application Priority Data
Jun. 6, 2008 (TW) 097121192

(51) Int. Cl. G06F 1/20

(52) U.S. Cl. 361/679.49

(57) ABSTRACT

A memory module includes a circuit board and a heat sink. The circuit board is disposed with multiple chip packages separated from each other by a spacing. The heat sink is attached to the chip packages and opened with multiple holes corresponding to the spacings. Thereby, a thermal air flow chamber is formed for an airflow to enter the spacings and exchange heat with the chip packages.

### CROSS-REFERENCE TO RELATED APPLICATIONS

This non-provisional application claims priority under 35 U.S.C. §119(a) on Patent Application No(s). 097121192 filed in Taiwan, R.O.C. on Jun. 6, 2008 the entire contents of which are hereby incorporated by reference.

### BACKGROUND OF THE INVENTION

1. Field of Invention

The present invention relates to a memory module, and more particularly to a memory module having a heat sink.

2. Related Art

With rapid development of the information technology industry and increasing popularization of the application of information media, various information products are widely utilized in people's lives. In addition to a higher operating speed of a microprocessor, its associated memory also plays quite an important role in improving the data processing capability of the information products. Such memory emphasizing high-speed access and associated with the microprocessor is called a random access memory (RAM), normally seen as a synchronous dynamic random access memory (SDRAM), double data rate SDRAM (DDR SDRAM), double data rate II SDRAM (DDRII SDRAM), or the like in the industry.

In a computer system, the RAM is used to preload data to accelerate the access of required data by a central processing unit (CPU). Therefore, the quality and speed of the RAM are critical enough to influence the efficiency and stability of the operation of the computer system. The longer the computer operates or the more programs the computer executes, the higher the temperature of the memory will be. Moreover, the heat dissipation effect of the memory also influences the operation of the computer system. The excessively high temperature of the memory due to poor heat dissipation effect may result in circumstances such as a breakdown or failure of the computer system. Therefore, the heat dissipation performance of the memory is rather important for a host device.

The RAM is inserted in a mainboard of the host device and cooled by an electric fan inside the host device. The electric fan is used to produce an airflow directly flowing through the surface of the memory to exchange heat with the memory and take away the heat, thereby lowering the temperature of the memory. However, for some high-speed memories employed in server hosts or professional graphics computers, due to great heat-generation wattage or excessively high setting density (compact arrangement) of the memory chips, the heat cannot be completely dissipated only by the airflow produced by the electric fan to flow through the surface of the memory. Thus, such high-speed memory is generally installed with a metal heat sink with good thermal conductivity. The heat sink contacts the memory chips to rapidly conduct out the heat, and then the heat is dissipated by the airflow from the electric fan.

However, the heat sink is usually disposed on one side of the memory and covers all the memory chips. As the memory chips are separated from each other by a spacing covered by the heat sink, a semi-closed space in which the airflow cannot perform convection is formed, and thus results in the difficulty of dissipating heat from the spacing within each memory chips. Once the memory is operates over a long period of time, the heat will be continuously accumulated on the sides and spacings of the memory chips and difficult to be dissipated, such that the temperature of the memory becomes excessively high. Although the heat sinks of some high-speed memories are opened with meshes, the contact area between the top surfaces of the memory chips and the heat sink is reduced, thus affecting the thermal conduction and alleviating the heat dissipation efficiency. Therefore, the design of the current high-speed memories fails to take the heat dissipation efficiency at every part of the memory chip into consideration, and still has room for improvement.

### SUMMARY OF THE INVENTION

The heat sink of the conventional memory may easily result in poor heat dissipation at the sides of the memory chips, or a reduced contact area due to the design of the meshes. Thus, the heat dissipation efficiency is affected, and it fails to take the heat dissipation effect at every part of the memory chip into consideration. Accordingly, the present invention is directed to a memory module having a heat sink, so as to enhance the heat dissipation efficiency of the memory chip while maintaining the original contact area for thermal conduction.

A memory module including a circuit board and at least one heat sink is provided. A plurality of chip packages is electrically disposed on at least one side of the circuit board, and the chip packages are separated from each other by a spacing. The heat sink is attached to the chip packages of the circuit board and is opened with a plurality of holes corresponding to the spacings between the chip packages, so as to form a thermal air flow chamber for airflow to exchange heat with the chip packages. Therefore, the heat generated by the chip packages during the operation of the memory module is transferred from the top surfaces of the packages to the heat sink by thermal conduction, and then taken away by the airflow. Moreover, the airflow may also perform convection in the thermal air flow chamber through the holes in the heat sink, so as to take away the heat from the sides of the chip packages through thermal convection and thermal conduction in the thermal air flow chamber.

The present invention achieves the following efficacies. As the heat sink is opened with multiple holes corresponding to the spacings of the chip packages, the airflow may perform thermal convection between the chip packages. Thereby, the heat dissipation effect at the sides of the chip packages is enhanced to avoid an accumulation of the heat between the chip packages. Meanwhile, a maximum contact area between the heat sink and the top surfaces of the chip packages is maintained to achieve good thermal conductivity.

### BRIEF DESCRIPTION OF THE DRAWINGS

The present invention will become more fully understood from the detailed description given herein below for illustration only, and thus are not limitative of the present invention, and wherein:

FIG. 1 is a three-dimensional exploded view of a first embodiment of the present invention;

FIG. 2 is a schematic three-dimensional view of the first embodiment of the present invention;

FIG. 3 is a schematic longitudinal sectional view of the first embodiment of the present invention;

FIG. 4 is a schematic cross-sectional view of the first embodiment of the present invention;

FIG. 5 is a schematic view illustrating the flow of airflows according to the first embodiment of the present invention;

FIG. 6A is a schematic three-dimensional view of the present invention applied to a mainboard;

FIG. 6B is a curve diagram of a temperature test performed on the present invention in FIG. 6A;

FIG. 7 is a three-dimensional exploded view of a second embodiment of the present invention; and

FIG. 8 is a schematic three-dimensional view of the second embodiment of the present invention.

### DETAILED DESCRIPTION OF THE INVENTION

The objectives, structures, features, and functions of the present invention will be illustrated in detail below in the accompanying embodiments.

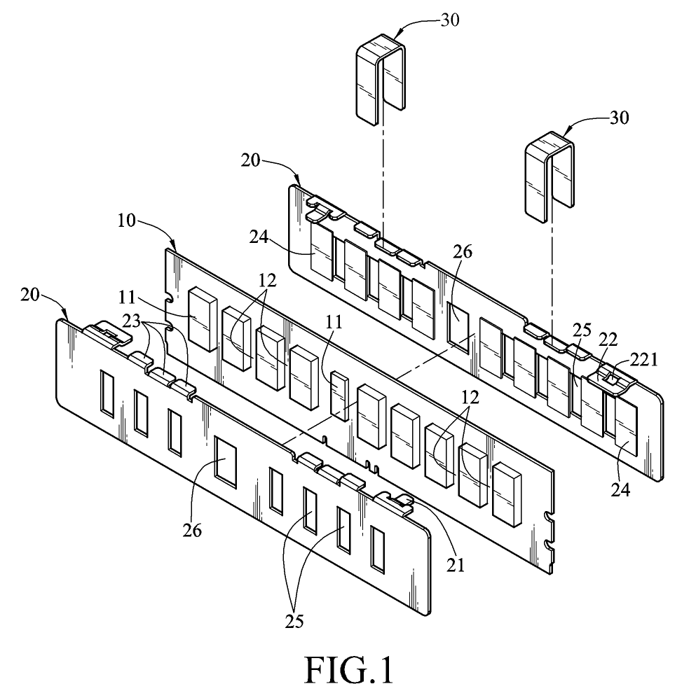

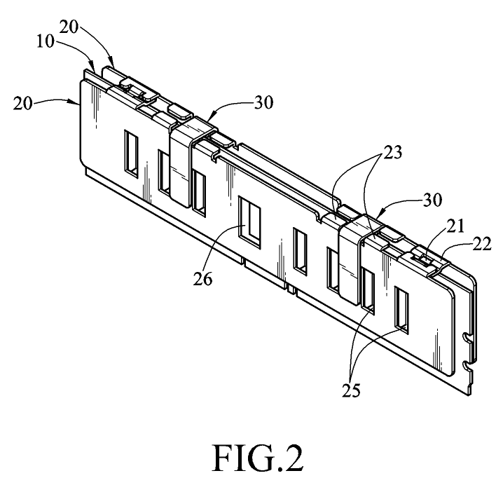

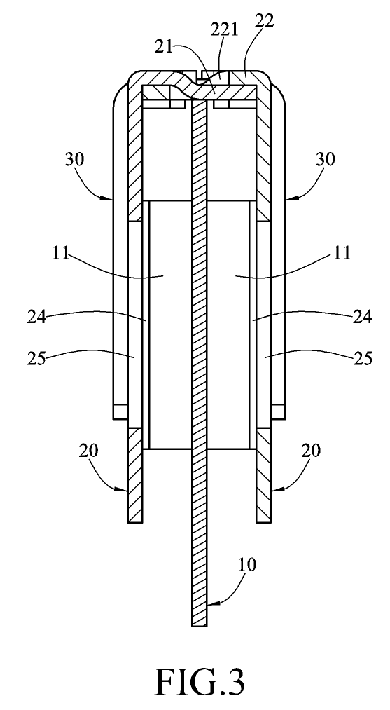

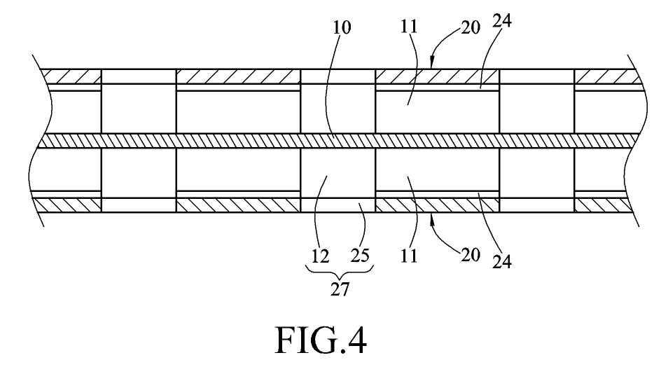

Referring to FIGS. 1 to 5, a first embodiment of the present invention is shown. The memory module provided by the first embodiment of the present invention includes a circuit board 10, two heat sinks 20, and two clamping members 30. The memory module of the present invention is substantially a RAM applied in a computer system, and more particularly a high-speed RAM applied in a server host and capable of being inserted in a mainboard of the server host or pulled out from the mainboard for replacement.

Referring to FIGS. 1, 2, and 3, a plurality of chip packages 11 is electrically disposed on the circuit board 10. In this embodiment, multiple chip packages 11 are electrically disposed on two sides (i.e., the broad surfaces) of the circuit board 10. The chip packages 11 can be classified into two types. One is disposed in the middle with a quantity of one, and encapsulated with a control chip. The other type of chip package 11 is in a large quantity and respectively encapsulated with a memory chip. The chip packages 11 on the circuit board 10 are separated from each other by a spacing 12.

Referring to FIGS. 1, 2, 3, and 4, the heat sinks 20 are attached to the chip packages 11 of the circuit board 10, and each heat sink 20 has a protruding claw 21, a protruding plate 22, two clamping plate sets 23, and a plurality of holes 25. In this embodiment, as the chip packages 11 are disposed on two sides of the circuit board 10, the heat sinks 20 are respectively disposed on the two sides of the circuit board 10. A thermal conductive adhesive 24 is disposed on one side of each heat sink 20 facing the circuit board 10. Thereby, the heat sink 20 is attached to and contacts the chip packages 11 through the thermal conductive adhesive 24, and thus the heat generated by the chip packages 11 can be rapidly transferred to the heat sink 20 via the thermal conductive adhesive 24. In addition to good thermal conductivity and adhesiveness, the thermal conductive adhesive 24 may be in the form of a continuous sheet entirely attached to the heat sink 20 with the portions overlapping the holes 25 cut out, or in the form of discontinuous sheets respectively attached between the holes 25.

The protruding claw 21 of each heat sink 20 is disposed corresponding to the protruding plate 22 of the other heat sink 20, and each protruding plate 22 has a retaining hole 221. Each protruding claw 21 is engaged with the retaining hole 221 in the corresponding protruding plate 22 so as to combine the two heat sinks 20. The clamping plate set 23 is constituted by three plates, and the plate in the middle is not at the same level as the other two, i.e., the plate in the middle is lower than the plates on two sides. The clamping member 30 is a bent flat spring made of a metal or plastic material. The clamping members 30 respectively clamp each heat sink 20 to the circuit board 10 at the central portions (i.e., the lower portions) of the clamping plate sets 23, so that the heat sinks 20, the thermal conductive adhesive 24, and the chip packages 11 remain in close contact, and thus the thermal conductivity is enhanced. Further, in the present invention, the number of the protruding claws 21, protruding plates 22, and clamping plate sets 23 of the heat sinks 20 is not limited, as long as the heat sinks 20 can be assembled to the circuit board 10, and the heat sinks 20, the thermal conductive adhesive 24, and the chip packages 11 remain in close contact.

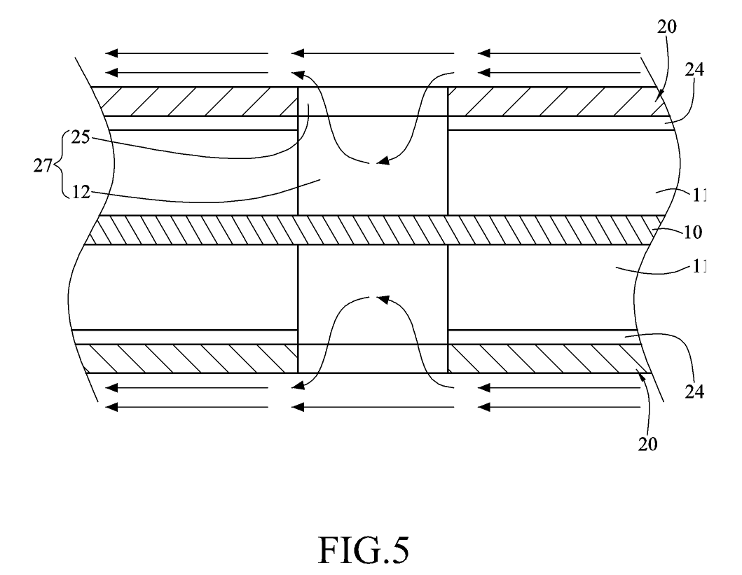

Referring to FIGS. 1, 3, 4, and 5, the holes 25 in each heat sink 20 are corresponding to the spacings 12 of the chip packages 11. That is, a hole 25 is opened in the heat sink 20 at a position corresponding to the portion between two adjacent chip packages 11. The hole 25 and the spacing 12 form a thermal air flow chamber 27 on one side of the circuit board 10 for an airflow to exchange heat with the chip packages 11. When the memory module of the present invention is applied in a server host, the memory module is cooled by an airflow produced by a heatsink fan in the server host. When passing through the surface of the heat sink 20, the airflow may enter the thermal air flow chamber 27 through the holes 25 and then exit the thermal air flow chamber 27 (as shown in FIG. 5), such that the airflows in and out of the thermal air flow chamber 27 form a convection and take away the heat from the sides of the chip packages 11. Further, the heat sink 20 is opened with an opening 26 larger than the size of the hole 25. The opening 26 is corresponding to the chip package 11 encapsulated with a control chip, and thus the above airflow may directly perform convection through the opening 26 so as to exchange heat with the chip package 11.

Referring to FIG. 5, when the memory module of the present invention is in operation, the chips in the chip packages 11 may generate heat, and the heat will be transferred to the surfaces (top surfaces and sides) of the chip packages 11. The heat transferred to the top surfaces of the chip packages 11 can be transferred to the heat sinks 20 by the thermal conductive adhesive 24 through thermal conduction and then taken away by the airflow flowing through the heat sinks 20. The heat transferred to the sides of the chip packages 11 can be taken away by the airflow entering the thermal air flow chamber 27 through thermal convection and thermal conduction in the thermal air flow chamber 27.

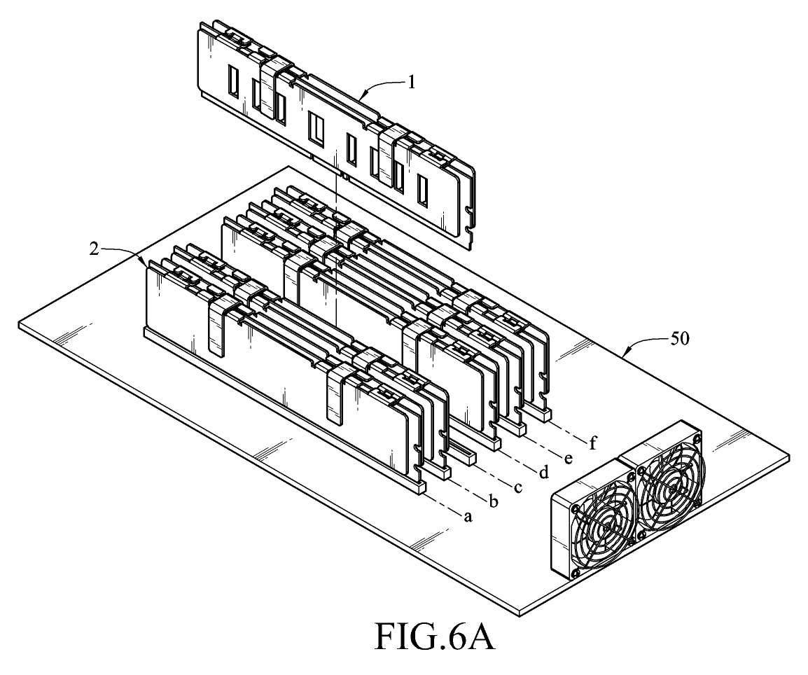

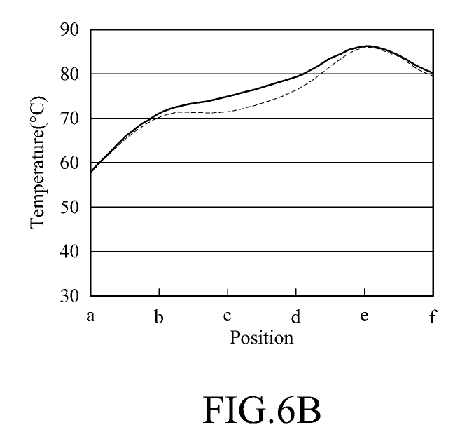

FIGS. 6A and 6B are respectively a three-dimensional view of a thermal flow test performed on the memory module of the present invention and a broken line graph of temperature-position data. During the thermal flow test, the memory module 1 of the present invention and conventional memory modules 2 having heatsinks with no holes are all installed on a mainboard 50. Six slots are disposed side by side on the mainboard 50 at positions a, b, c, d, e, and f, and can be inserted by the memory modules 1 and 2, respectively. Further, heatsink fans corresponding to the slots are disposed on the mainboard 50, so as to produce airflows toward the slots to cool the memory modules 1 and 2 inserted in the slots. In FIG. 6B, coordinates on the temperature axis refer to Celsius temperatures (° C.) measured on the memory modules 1 and 2, and coordinates on the position axis refer to the corresponding positions a, b, c, d, e, and f of all the slots.

In FIG. 6A, the slots at the positions a, b, d, e, and f are inserted with the conventional memory modules 2 for comparison, and the slot at the position c is inserted with the memory module 1 of the present invention. Under the actual thermal flow experimental test, a solid line in FIG. 6B reflects the temperature data respectively measured on the conventional memory modules 2 (having heat sinks with no holes) inserted in the slots at the positions a, b, c, d, e, and f (not shown). In addition, a dashed line in FIG. 6B reflects the temperature data respectively measured on the electric memory modules 2 at the positions a, b, d, e, f and on the electric memory modules 1 at the positions c when the slots at the positions a, b, d, e, and f are inserted with the memory modules 2 and the slot at the position c is inserted with the memory module 1 of the present invention, i.e., the measurement is performed according to the configuration in FIG. 6A. By comparison, although inserted in the same slot at the position c, the temperature of the memory module 1 opened with holes (as shown by the dashed line) is obviously lower than that of the memory module 2 with no holes (as shown by the solid line). Thereby, the memory module 1 of the present invention indeed achieves a better heat dissipation efficiency, and lowers the temperature of the chip packages.

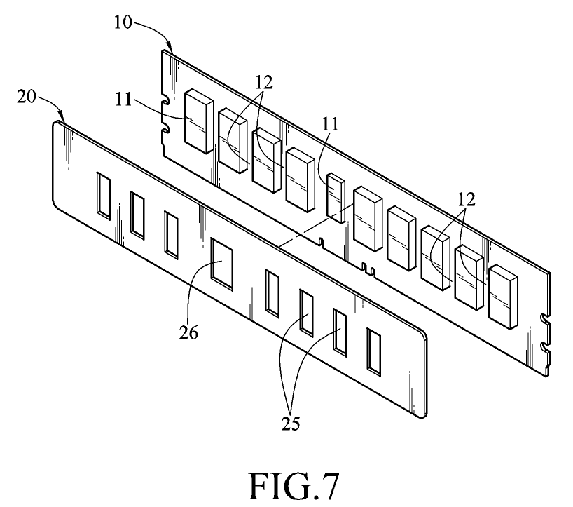

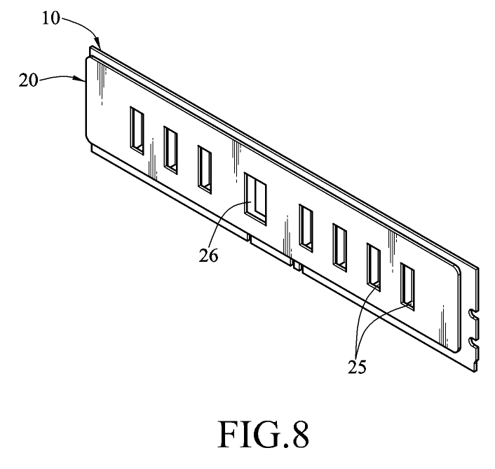

Referring to FIGS. 7 and 8, a second embodiment of the present invention is shown. The implementation of this embodiment is similar to that of the first embodiment, and the only difference lies in the disposing manner of the chip packages on the circuit board and the number of the associated heat sinks. The memory module provided by the second embodiment of the present invention includes a circuit board 10 and two heat sinks 20. In this embodiment, a plurality of chip packages 11 is only electrically disposed on one side (i.e., a broad surface) of the circuit board 10. Therefore, the heat sinks 20 are only installed on one side of the circuit board 10. The heat sinks 20 are attached to the chip packages 11 of the circuit board 10 and opened with a plurality of holes 25. In particular, the heat sinks 20 are attached to and contact the chip packages 11 through a thermal conductive adhesive (not shown), and thus the heat generated by the chip packages 11 can be rapidly transferred to the heat sinks 20 via the thermal conductive adhesive. Similarly, each hole 25 in the heat sinks 20 is opened corresponding to a spacing 12 between two adjacent chip packages 11, such that an external airflow can take away the heat from the sides of the chip packages 11 through thermal convection and thermal conduction.

According to the present invention, as the heat sink is opened with multiple holes corresponding to the spacings of the chip packages, the airflow may perform thermal convection between the chip packages. Thereby, the heat dissipation effect at the sides of the chip packages is enhanced to avoid an accumulation of the heat between the chip packages. Meanwhile, a maximum contact area between the heat sink and the top surfaces of the chip packages is maintained to achieve good thermal conductivity.

What is claimed is:

1. A memory module, comprising:
a circuit board, electrically disposed with a plurality of chip packages on at least one side, wherein the chip packages are arranged on the circuit board while separated from each other by a spacing; and
at least one heat sink, attached to the chip packages and opened with a plurality of holes corresponding to the spacings, so as to form a thermal air flow chamber for an airflow to exchange heat with the chip packages.

2. The memory module according to claim 1, comprising two heat sinks respectively disposed on two sides of the circuit board.

3. The memory module according to claim 2, wherein one heat sink is provided with a protruding claw, and the other with a protruding plate corresponding to the protruding claw, the protruding plate has a retaining hole, and the protruding claw is engaged with the retaining hole of the protruding plate to combine the two heat sinks.

4. The memory module according to claim 1, wherein the heat sink is further provided with a thermal conductive adhesive on one side facing the circuit board, and the heat sink contacts the chip packages through the thermal conductive adhesive.

5. The memory module according to claim 4, further comprising at least one clamping member for clamping the heat sink to the circuit board, such that the heat sink, the thermal conductive adhesive, and the chip packages remain in close contact.
